(19) United States
(12) Patent Application Publication
(10) Pub. No.: US 2025/0136204 A1
(43) Pub. Date: May 1, 2025

(54) ARTICULATION ASSEMBLY FOR A VEHICLE WITH A TRACK SYSTEM

(71) Applicant: SOUCY INTERNATIONAL INC., Drummondville (CA)

(72) Inventor: Jeremie AUBIN-MARCHAND, Saint-Hugues (CA)

(21) Appl. No.: 18/926,399

(22) Filed: Oct. 25, 2024

Related U.S. Application Data
(60) Provisional application No. 63/593,087, filed on Oct. 25, 2023.

(51) Int. Cl. B62D 55/30; B62D 55/10; B62D 55/104; B62D 55/14

(52) U.S. Cl. CPC B62D 55/305; B62D 55/10; B62D 55/104; B62D 55/14

(57) ABSTRACT

An articulation assembly for an axle of a wheel assembly of a vehicle track system comprising: a composite movement component configured to connect the axle to a track system frame, and to permit the axle to move relative to the frame as a composite movement having a composite axis, the composite axis extending along a longitudinal centre plane of the track system, the composite movement comprising a yaw movement component and a roll movement component such that when the axle of the wheel assembly moves relative to the frame, the roll movement component and the yaw movement component occur simultaneously.

### CROSS-REFERENCE TO RELATED APPLICATION

This application claims the benefit of and priority to U.S. provisional patent application No. 63/593,087, filed on Oct. 25, 2023; the content of which is herein incorporated in entirety by reference.

### TECHNICAL FIELD

The present application generally relates to an articulation assembly for a track system for a vehicle, and more specifically to an articulation assembly configured to permit movement between a wheel assembly of the track system and a frame of the vehicle.

### BACKGROUND

Certain vehicles, such as, for example, agricultural vehicles (e.g., harvesters, combines, tractors, etc.), construction vehicles (e.g., trucks, front-end loaders, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicles along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads.

Typically, track systems comprise an endless track extending around a frame and wheel assemblies. For proper operation, the endless track must maintain a predetermined tension in the track. Tensioning assemblies are provided for applying a predetermined outward force to one or more of the wheel assemblies supporting the endless track. However, when the endless track meets an obstacle such as a rock on the ground or a pothole, external forces on the endless track where the endless track meets the obstacle are increased locally. Uneven stresses on the endless track can result in premature wear and failure of the endless track, and even disengagement of the endless track from the wheel assemblies.

Therefore, there is a desire for track systems that mitigate the above-mentioned issues.

### SUMMARY

It is an object of the present technology to ameliorate at least some of the inconveniences present in the prior art.

From a broad aspect there is provided an articulation assembly for an axle of a wheel assembly of a track system of a vehicle, the articulation assembly comprising: a composite movement component configured to connect the axle of the wheel assembly to a frame of the track system, and configured to permit the axle of the wheel assembly to move relative to the frame as a composite movement having a composite axis, the composite axis extending along a longitudinal centre plane of the track system, the composite movement comprising a yaw movement component and a roll movement component such that when the axle of the wheel assembly moves relative to the frame, the composite movement comprises the roll movement and the yaw movement occurring simultaneously.

In certain embodiments, the composite axis is angularly off-set by a first acute angle from a portion of a transverse axis of the track system which is above a horizontal axis, the horizontal axis being transverse with the composite axis at the longitudinal centre plane.

In certain embodiments, the composite axis is angled forwardly with respect to the frame.

In certain embodiments, the composite axis is angled rearwardly with respect to the frame.

In certain embodiments, the composite axis is substantially vertical.

In certain embodiments, the composite axis is substantially transverse to a resultant force direction of a tension in an endless track of the track system.

In certain embodiments, the composite axis is perpendicular to a resultant force direction of a tension in the endless track of the track system.

In certain embodiments, the resultant force is applied to the axle of the wheel assembly.

In certain embodiments, the articulation assembly further comprises a tensioning assembly configured to resiliently bias the wheel assembly away from the frame and towards an endless track of the track system, wherein the articulation assembly is connected to the tensioning assembly.

In certain embodiments, the articulation assembly is disposed on the axle, or is disposed between the axle and the tensioning assembly.

In certain embodiments, the articulation assembly further comprises a tensioning assembly configured to resiliently bias the wheel assembly away from the frame and towards an endless track of the track system, wherein the articulation assembly is connected to the frame.

In certain embodiments, the articulation assembly is disposed between the tensioning assembly and the frame, or is positioned between first and second portions of the frame.

In certain embodiments, the composite movement component comprises at least one member of interconnecting members associated with the axle and the frame respectively, the interconnecting members being moveable relative to each other in at least two degrees of freedom to permit the composite movement.

In certain embodiments, the composite movement component comprises a pivot joint.

In certain embodiments, the composite movement component comprises a ball joint.

In certain embodiments, the articulation assembly further comprises at least one stopper for delimiting the composite movement.

In certain embodiments, the wheel assembly comprises two wheels, spaced from one another and connected to the axle, and wherein the two wheels are configured to contact respective portions on an inner surface of the endless track.

In certain embodiments, the wheel assembly comprises an idler wheel assembly.

In certain embodiments, the wheel assembly comprises a support wheel assembly.

From another aspect, there is provided an articulation assembly for an axle of a wheel assembly of a track system of a vehicle, the articulation assembly comprising: a composite movement component configured to connect the axle of the wheel assembly to a frame of the track system, and configured to permit the axle of the wheel assembly to move relative to the frame as a composite movement having a composite axis, the composite axis extending along a longitudinal centre plane of the track system, the composite movement having at least two degrees of freedom.

In certain embodiments, the at least two degrees of freedom comprise a roll movement component and a yaw movement component.

In certain embodiments, the articulation assembly further comprises a tensioning assembly, the at least two degrees of freedom comprising three degrees of freedom.

In certain embodiments, the wheel assembly comprises an idler wheel assembly.

In certain embodiments, the wheel assembly comprises a support wheel assembly.

From a yet further aspect, there is provided an articulation assembly for an axle of a wheel assembly of a track system of a vehicle, the wheel assembly comprising an endless track supported by wheels, the articulation assembly comprising: a composite movement component configured to connect the axle of the wheel assembly to a frame of the track system, and configured to permit the axle of the wheel assembly to move relative to the frame as a composite movement having a composite axis, the composite axis extending along a longitudinal centre plane of the track system, the composite movement comprising a yaw movement component and a roll movement component such that when the axle of the wheel assembly moves relative to the frame, the composite movement is configured to evenly distribute a stress within the endless track when the endless track is contact with uneven ground.

In certain embodiments, the wheel assembly comprises an idler wheel assembly.

In certain embodiments, the wheel assembly comprises a support wheel assembly.

From a yet further aspect, there is provided a wheel assembly for a track system for a vehicle, the wheel assembly comprising an axle supporting wheels, and an articulation assembly configured to connect the axle to a frame of the track system and to permit a composite movement, the articulation assembly as defined herein.

In certain embodiments, the wheel assembly comprises an idler wheel assembly.

In certain embodiments, the wheel assembly comprises a support wheel assembly.

From another aspect, there is provided a track system for a vehicle, the track system comprising: a frame; at least one wheel assembly having an axle supporting wheels; an endless track supported by the wheels; an articulation assembly configured to connect the axle to a frame of the track system and to permit a composite movement with a composite axis, the articulation assembly as defined herein.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle having track systems, according to embodiments of the present technology;

FIG. 2 is a perspective view taken from a bottom, front, left side of one of the track systems of FIG. 1, the track system having a leading wheel assembly with an articulation assembly, according to embodiments of the present technology;

FIGS. 3A and 3B are partial front, left perspective views of the leading wheel assembly and the articulation assembly of FIG. 2, according to embodiments of the present technology;

FIG. 4A is a schematic illustration of the track system of FIG. 2 when viewed from the side and showing different composite axes of the articulation assembly, according to embodiments of the present technology;

FIG. 4B is a partial top view normal to one of the different composite axes of the leading wheel assembly of the track system of FIG. 4A, according to embodiments of the present technology;

FIG. 4C is the schematic illustration of the track system of FIG. 4A showing a composite axis of the articulation assembly and a resultant force of the track system, according to embodiments of the present technology;

FIG. 5A is the leading wheel assembly and the articulation assembly of FIG. 3A meeting an obstacle, according to embodiments of the present technology;

FIG. 5B is a side view of a track system which includes the leading wheel assembly of FIG. 5A, according to embodiments of the present technology;

FIG. 5C is a partial top view normal to composite axis a1 of the track system of FIG. 5B, according to embodiments of the present technology;

FIG. 6 is a close-up of the leading wheel assembly of FIG. 4A and showing different positions of the articulation assembly, according to embodiments of the present technology; and

FIGS. 7A-7D are the top views normal to one of the different composite axes of FIG. 4A and including the different positions of the articulation assembly of FIG. 6, according to embodiments of the present technology.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

### Off-Road Vehicle

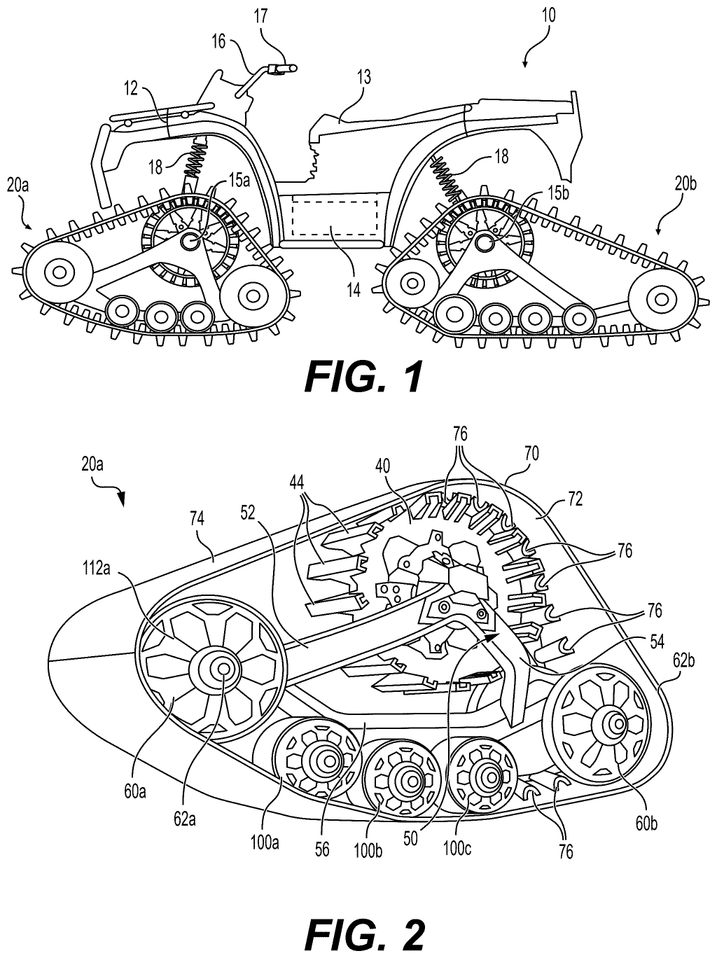

Referring to FIG. 1, the present technology will be described with reference to a vehicle 10. The vehicle 10 is an off-road vehicle 10. More precisely, the vehicle 10 is an all-terrain vehicle 10. It is contemplated that in other embodiments, the vehicle 10 could be another type of recreational vehicle such as a snowmobile, a side-by-side vehicle or a utility-task vehicle.

In yet other embodiments, the vehicle is an agricultural vehicle such as a harvester, a combine or a tractor. In other embodiments, the vehicle is a construction vehicle such as a bulldozer, a skid-steer loader, an excavator or a compact track loader. It is further contemplated that the present technology could be used with industrial and military vehicles as well. It is also contemplated that the present technology could be used with trailers or other unpowered vehicles.

A person skilled in the art will understand that it is also contemplated that some aspects of the present technology in whole or in part could be applied to other types of vehicles such as, for example, agricultural vehicles, industrial vehicles, military vehicles or exploratory vehicles.

The vehicle 10 has two front track systems 20a (only the left one is shown in the accompanying Figures) in accordance with embodiments of the present technology, and two rear track systems 20b (only the left one is shown in the accompanying Figures) also in accordance with embodiments of the present technology. In some embodiments, the vehicle 10 could have more or less than four track systems.

The vehicle 10 includes a frame 12, a straddle seat 13 disposed on the frame 12, a powertrain 14 (shown schematically), a steering system 16, a suspension system 18, and the track systems 20a, 20b.

The powertrain 14, which is supported by the frame 12, is configured to generate power and transmit said power to the track systems 20a, 20b via driving axles, thereby driving the vehicle 10. More precisely, the front track systems 20a are operatively connected to a front axle 15a of the vehicle 10 and, the rear track systems 20b are operatively connected to a rear axle 15b of the vehicle 10. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle). In some embodiments, the track systems 20a, 20b are operatively connected to non-driven axle of unpowered vehicles (e.g. trailer).

The steering system 16 is configured to enable an operator of the vehicle 10 to steer the vehicle 10. To this end, the steering system 16 includes a handlebar 17 that is operable by the operator to direct the vehicle 10 along a desired course. In other embodiments, the handlebar 17 could be replaced by another steering device such as, for instance, a steering wheel. The steering system 16 is configured so that in response to the operator handling the handlebar 17, an orientation of the front track systems 20a relative to the frame 12 is changed, thereby enabling the vehicle 10 to turn in a desired direction.

The suspension system 18, which is connected between the frame 12 and the track systems 20a, 20b allows relative motion between the frame 12 and the track systems 20a, 20b, and can enhance handling of the vehicle 10 by absorbing shocks and assisting in maintaining adequate traction between the track systems 20a, 20b and the ground.

The track systems 20a, 20b are configured to compensate for and/or otherwise adapt to the suspension system 18 of the vehicle 10. For instance, the track systems 20a, 20b are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the vehicle 10 could have been originally designed to use wheels instead of the track systems, the alignment settings could originally have been set to optimize travel, handling, ride quality, etc. of the vehicle 10 with the use of wheels. Since the track systems 20a, 20b are structurally different and behave differently from wheels, the track system 20a, 20b may be configured to compensate for and/or otherwise adapt to the alignment settings to enhance their traction and/or other aspects of their performances and/or use.

### Track System

Referring now to FIG. 2, the track systems 20a, 20b will be described in greater detail. As the front and rear track systems 20a, 20b are generally similar, only the front left track system 20a will be described herein.

The track system 20a includes a drive wheel assembly 40 which is operatively connectable to the driving axle 15a. The driving axle 15a can drive the drive wheel assembly 40 to drive the track system 20a. The drive wheel assembly 40 defines laterally extending engaging members 44 (i.e., teeth) disposed on the circumference of the drive wheel assembly 40. The engaging members 44 are adapted, as will be described in greater detail below, to engage with lugs 76 provided on an inner surface 72 of an endless track 70 of the track system 20a. It is contemplated that in other embodiments, the configuration of the drive wheel assembly 40 and thus the manner in which the drive wheel assembly 40 engages the endless track 70 could differ without departing from the scope of the present technology.

The track system 20a further includes a frame 50. The frame 50 includes a leading frame member 52, a trailing frame member 54 and a lower frame member 56. The leading and trailing frame members 52, 54 are jointly connected around the driving axle 15a, the joint connection being positioned laterally outwardly from the drive wheel assembly 40. The leading frame member 52 extends forwardly and downwardly from the joint connection and connects to a forward portion of the lower frame member 56. The trailing frame member 54 extends rearwardly and downwardly from the joint connection and connects to a rearward portion of the lower frame member 56. The lower frame member 56, which is positioned below the joint connection, extends generally parallel to the forward direction of travel of the vehicle. In the present embodiment, the leading, trailing and lower frame members 52, 54, 56 are integral. It is contemplated that in other embodiments, the leading, trailing and lower frame members 52, 54, 56 could be distinct members connected to one another. It is contemplated that in other embodiments, the configuration of the frame 50 could differ without departing from the scope of the present technology. For instance, it is further contemplated that in some embodiments, the frame 50 could include more or less than three members. In some embodiments, one or more of the leading, trailing and lower frame members 52, 54, 56 could be pivotally connected to one another.

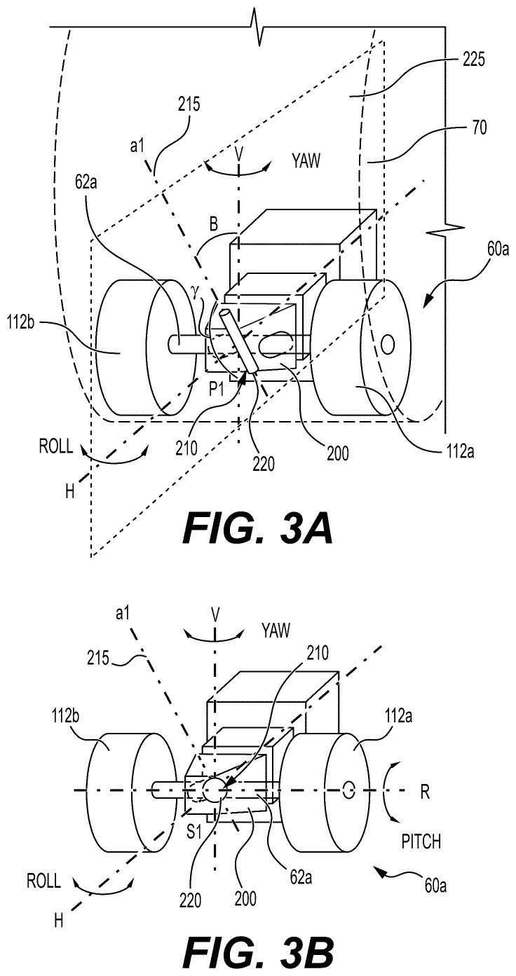

With continued reference to FIG. 2, the track system 20a further includes a leading idler wheel assembly 60a, a trailing idler wheel assembly 60b, and a plurality of support wheel assemblies 100a, 100b, 100c. In this embodiment, the track system 20a includes three support wheel assemblies, but it is contemplated that the track system 20a could include more or less than three support wheel assemblies. Each of the leading and trailing idler wheel assemblies 60a, 60b and the support structures 100a, 100b, 100c includes two laterally spaced wheels 112a, 112b (FIG. 3). The two laterally spaced wheels 112a, 112b are also referred to herein as left and right wheels 112a, 112b. It is contemplated that in some embodiments, at least one of the leading and trailing idler wheel assemblies 60a, 60b, and the support wheel assemblies 100a, 100b, 100c could have a single wheel, or three or more laterally spaced wheels.

The leading idler wheel assembly 60a has a wheel axle 62a which supports the left and right wheels 112a, 112b, and is rotationally connected to a leading end of the lower frame member 56. The trailing idler wheel assembly 60b has a wheel axle 62b and is rotationally connected to a trailing end of the lower frame member 56. The support wheel assemblies 100a, 100b, 100c are at least indirectly rotationally connected to the lower frame member 56 longitudinally between the leading and trailing idler wheel assemblies 60a, 60b.

In some embodiments, at least one of the leading and trailing idler wheel assemblies 60a, 60b is at least indirectly connected to the lower frame member 56 via a tensioning assembly 200 (FIGS. 3A and 3B). The tensioning assembly 200 is operable to adjust a tension in the endless track 70 by moving a given one or both of the leading and trailing idler wheel assemblies 60a, 60b toward or away from the frame 50. More specifically, the tensioning assembly 200 comprises a tensioning mechanism (not shown) that biases the leading and trailing idler wheel assemblies 60a, 60b away from the frame 50 in order to obtain and/or maintain a predetermined tension in the endless track 70.

The track system 20a also includes the endless track 70, which extends around components of the track system 20a, notably the frame 50, the leading and trailing idler wheel assemblies 60a, 60b and the support wheel assemblies 100a, 100b, 100c. The endless track 70 has the inner surface 72 and an outer surface 74. The inner surface 72 of endless track 70 has lugs 76 (shown in FIG. 2). The lugs 76 are adapted to engage with the engaging members 44 of the drive wheel assembly 40. As mentioned previously, other engagement configurations between the drive wheel assembly 40 and the endless track 70 are contemplated as well. The outer surface 74 of the endless track 70 has a tread defined thereon. It is contemplated that the tread could vary from one embodiment to another. In some embodiments, the tread could depend on the type of vehicle 10 on which the track system 20a is to be used and/or the type of ground surface on which the vehicle 10 is destined to travel. In the present embodiment, the endless track 70 is an elastomeric endless track. Specifically, the endless track 70 is a polymeric endless track. It is contemplated that in some embodiments, the endless track 70 could be constructed of a wide variety of materials and structures.

### Articulation Assembly

Referring to FIGS. 3A and 3B, according to embodiments of the present technology, there is provided an articulation assembly 210 which is configured to connect the axle 62a of the leading wheel assembly 60a to the frame 50 of the track system 20a and to allow relative movement between the leading wheel assembly 60a and the frame 50 in a manner that permits the leading wheel assembly 60a to undergo a composite movement comprising “roll” and “yaw” movement elements about a composite axis 215. The articulation assembly 210 is described herein in relation to the leading wheel assembly 60a but can equally be connected to the trailing idler wheel assembly 60b.

### Composite Movement Component

The articulation assembly 210 comprises a composite movement component 220 which comprises at least one member of interconnecting members associated with the wheel axle 62a and the frame 50 respectively, the interconnecting members being moveable relative to each other to permit the composite movement.

In certain embodiments, the composite movement component 220 comprises a pivot joint (FIG. 3A). In certain embodiments, the composite movement component 220 comprises a ball joint (FIG. 3B). In other embodiments, the composite movement component 220 may comprise any other type of joint such as a loose bolt in an opening, a resilient joint, or a universal joint. In yet other embodiments, the composite movement component 220 may comprise a functionally equivalent mechanism to a joint. It will be appreciated that in embodiments in which the composite movement component 220 comprises a ball joint, the composite movement occurs about a point which lies on the composite axis 215, whereas in embodiments in which the composite movement component 220 comprises a pivot joint, the composite movement occurs about the composite axis 215.

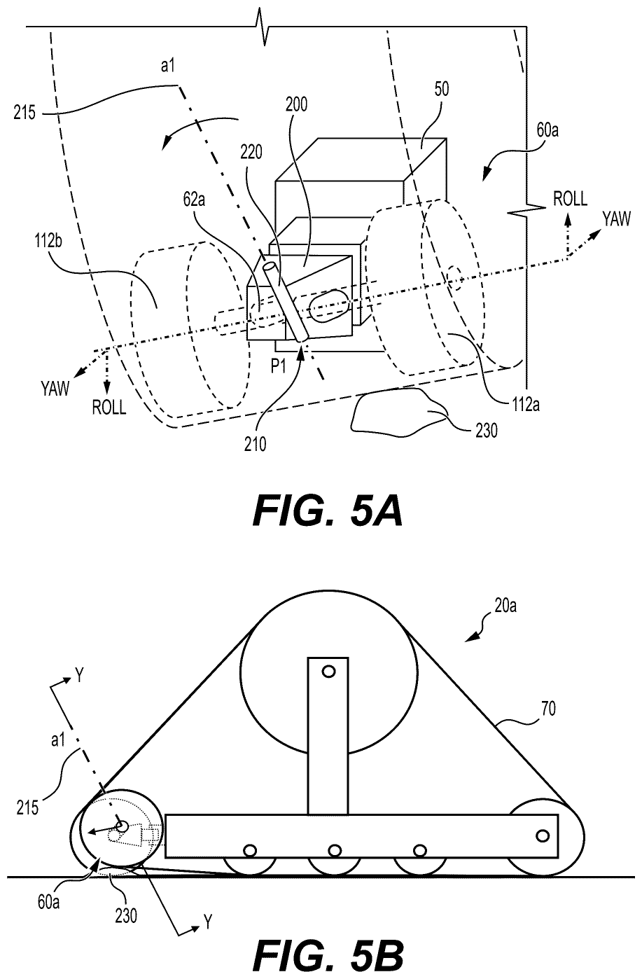

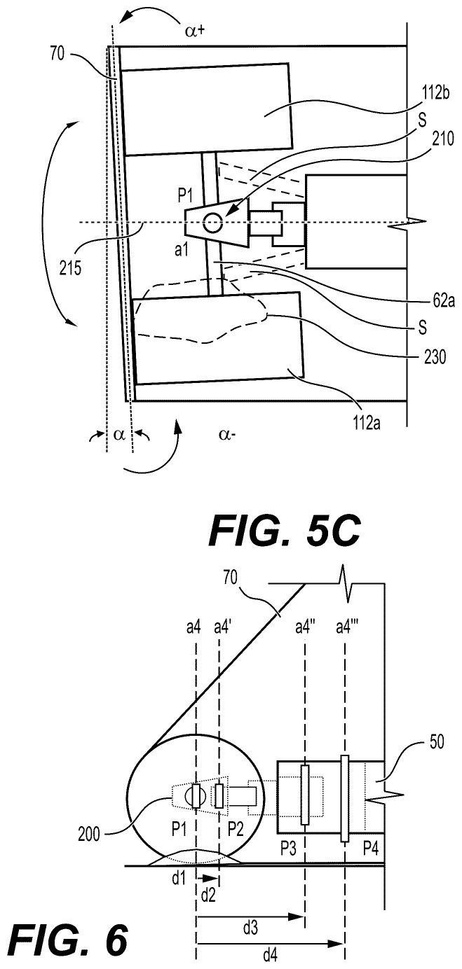

In certain embodiments, there is further provided a stopper S schematically shown in FIG. 5C for delimiting the composite movement.

### Composite Axis

Referring to FIG. 3A, the composite axis 215 is indicated as a1 according to certain embodiments. In the embodiment of FIGS. 3A and 3B, the composite axis 215 is angled forwardly with respect to the frame 50. The composite axis 215 extends through a longitudinal centre plane 225 and crosses with a longitudinal axis H and a transverse axis V of the track system 20a. In the embodiment shown, the longitudinal axis H is horizontal and is a roll axis of the track system 20a, and the transverse axis is vertical and is a yaw axis of the track system 20a. However, it will be appreciated that the longitudinal and transverse axes H, V, may be off-set from the horizontal and vertical of the track system 20a.

The composite axis 215 may be angularly off-set, or not, from the transverse axis V by any appropriate angle. In the figures and description herein, the angular off-set is defined in terms of an angle between: (i) a portion of the transverse axis V above the longitudinal axis H and the composite axis 215. The angular off-set is indicated as an acute angle ß in FIG. 3A.

It will be appreciated, that the angular off-set can also be stated with reference to the portion of the transverse axis V below the longitudinal axis H, in which case the angular off-set would be an obtuse angle for the composite axis a1 (indicated as angle Y in FIG. 3A).

Similarly, the angular off-set can be defined relative to the longitudinal axis H. For example, the composite axis a1 can be said to be angularly off-set from a portion of the longitudinal axis H which is forwardly of the transverse axis V by an acute angle, or the composite axis a1 is angularly off-set from a portion of the longitudinal axis H which is rearwardly of the transverse axis V by an obtuse angle.

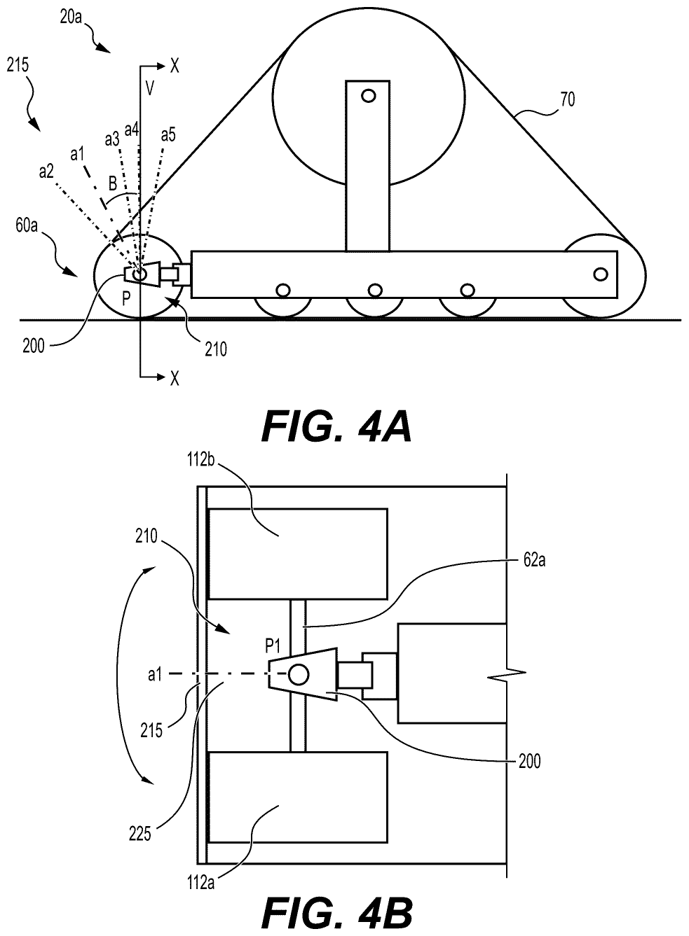

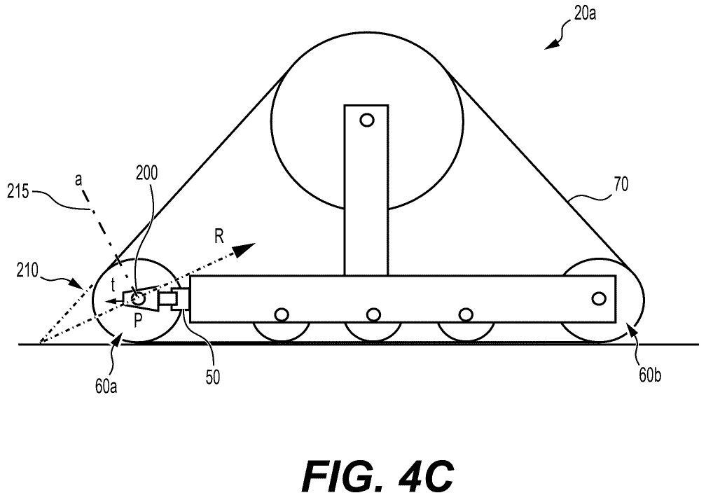

Certain other embodiments of the composite axis 215 are illustrated in FIG. 4A: a2, a3, a4 and a5. Like the composite axis a1, composite axes a2 and a3 also extend along the longitudinal centre plane 225 of the track system 20a, and are also angled forwardly with respect to the frame 50, albeit at a different angular off-set to the transverse axis V than the composite axis a1. Composite axis a4 is substantially vertical and also extends along the longitudinal centre plane 225 of the track system 20a. Composite axis a5 is angularly off-set from the transverse axis V and also extends along the longitudinal centre plane 225 of the track system 20a. Composite axis a5 extends rearwardly from the portion of the transverse axis V above the longitudinal axis H. The composite axes a2, a3 and a5 have respective angular off-sets which are an acute angle relative to the portion of the transverse axis V above the longitudinal axis H and transverse with the composite axis 215 at the longitudinal axis H. When described relative to the longitudinal axis H, the composite axis a5 can be said to have an obtuse angular off-set relative to a portion of the longitudinal axis H forwardly of a point at which the composite axis crosses the longitudinal axis H. Whereas, a1, a2 and a3 can be said to have an acute angular off-set relative to the portion of the longitudinal H axis forwardly of the point at which the composite axes cross the longitudinal axis H.

FIG. 4B illustrates a partial top view and illustrates the composite axis extending along the longitudinal centre plane 225.

As best seen in FIG. 4C, the composite axis a1 is transverse to, and substantially perpendicular to, a resultant force direction R of a tension in the endless track 70 of the track system 20a. The resultant force is applied to the axle 62a of the leading wheel assembly 60a. In such embodiments, a force against the resultant force is thus maximised. The resultant force can be derived by determining a biasing force of the tensioning assembly, and opposing forces in the track 70, such as between the drive wheel assembly 40 and the leading wheel assembly 60a, the drive wheel assembly 40 and the trailing wheel assembly 60b, and the leading and trailing wheel assemblies 60a, 60b. The resultant force direction R may differ from that illustrated in FIG. 4C.

In certain embodiments, the composite axis 215 being vertical (e.g. a4) may be beneficial for toe-in/toe-out movement (yaw movement).

In certain other embodiments, the composite axis 215 being angularly off-set from the vertical may provide stability if the articulation assembly 210 is used with the trailing wheel assembly 60b.

### Position

Referring now to FIG. 6, a position of the articulation assembly 210 will now be described with reference to the tensioning assembly 200. However, it will be appreciated that in certain embodiments, the track system 20a may comprise the articulation assembly 210 without the tensioning assembly 200.

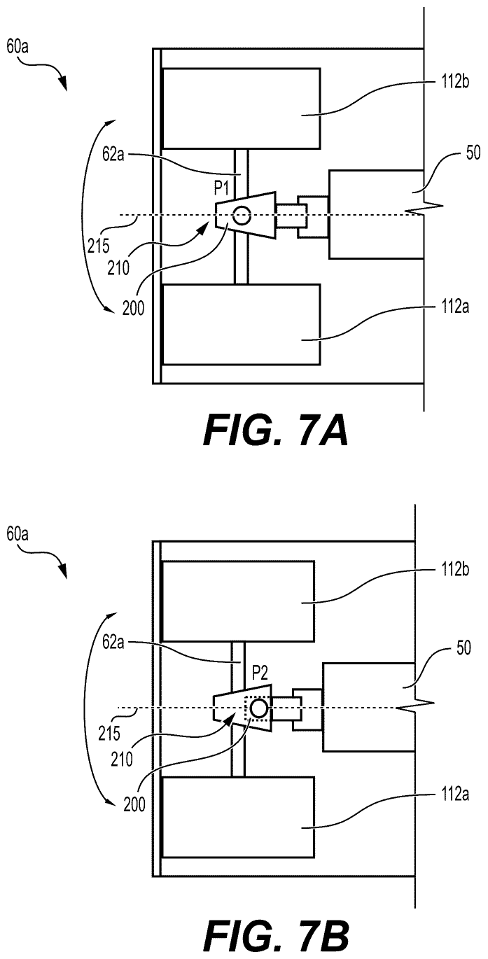

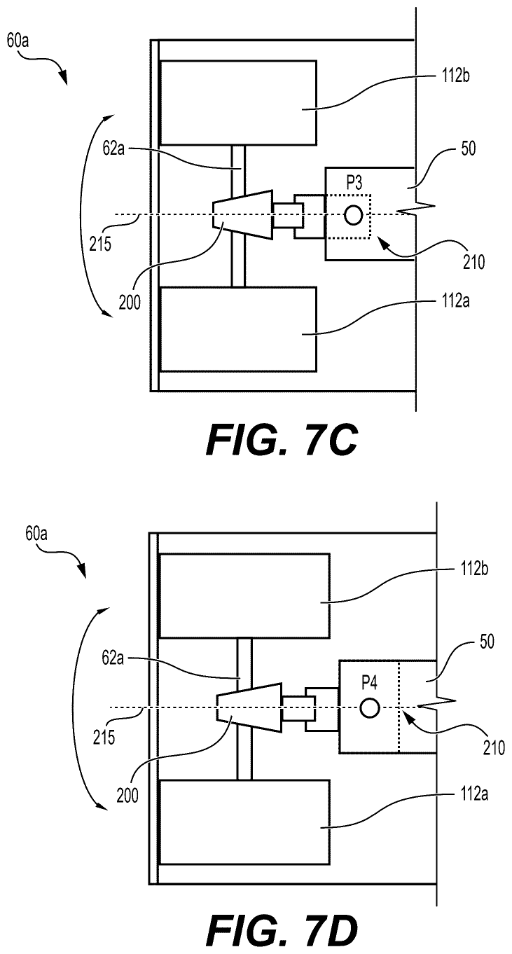

In certain embodiments in which there is provided a tensioning assembly 200, the articulation assembly 210 may be connected to the tensioning assembly 200 and facing the frame 50 (P1, P2). In position P1, the articulation assembly 210 is disposed directly on the leading wheel assembly 60a at distance d1 from the wheel axle 62a (null) (FIG. 7A). In position P2, the articulation assembly 210 is disposed between the axle 62a of the leading wheel assembly 60a and the tensioning assembly 200, at distance d2 from the wheel axle 62a (FIG. 7B).

In yet other embodiments in which there is provided a tensioning assembly 200, the articulation assembly 210 may be connected to the frame 50 and facing the tensioning assembly 200 (P3, P4). In position P3, the articulation assembly 210 is disposed between the tensioning assembly 200 and the frame 50, at distance d3 from the wheel axle 62a (FIG. 7C). In position P4, the articulation assembly 210 is disposed between a first portion of the frame and a second portion of the frame 50, at distance d4 from the wheel axle 62a (FIG. 7D). It will be apparent to persons skilled in the art that other positions of the articulation assembly 210 are within the scope of the present technology.

### Composite Movement

The composite movement will now be described with reference to FIGS. 3A, 3B, 5A-5C. As best seen in FIGS. 3A and 3B, an isolated roll movement of the leading wheel assembly 60a comprises a pivot about a roll axis, causing one of the left and right wheels 112a, 112b of the leading wheel assembly 60a to move upwardly whilst the other of the left and right wheels 112a, 112b of the leading wheel assembly 60a moves downwardly. The roll axis is illustrated as a longitudinal axis H which is horizontal.

Still referring to FIGS. 3A and 3B, an isolated yaw movement of the leading wheel assembly 60a comprises a pivot about a yaw axis, causing one of the left and right wheels 112a, 112b of the leading wheel assembly 60a to move forwardly whilst the other of the left and right wheels 112a, 112b of the leading wheel assembly 60a moves backwardly. The yaw axis is illustrated as a vertical axis V.

In embodiments of the present technology, the composite movement includes yaw and roll components as will be described below.

FIGS. 5A-5C illustrate the composite movement of the leading wheel assembly 60a as the left wheel 112a of the leading wheel assembly 60a encounters an obstacle 230. An obstacle may comprise anything that makes the ground uneven such as one or both of: convex object(s) on the ground, such as a rock, or concave deficiencies, such as a pothole. As can be seen, the composite movement comprises movement of the left wheel 112a upwardly relative to the frame about the composite axis a1 and movement of the left wheel backwardly relative to the frame about the composite axis a1. The right wheel 112b is subsequently caused to move downwardly and forwardly relative to the frame. Similarly, when the right wheel 112b of the leading wheel assembly 60a encounters a convex obstacle 230, the composite movement of the leading wheel assembly 60a comprises movement of the right wheel 112b upwardly relative to the frame about the composite axis a1 and movement of the left wheel 112a backwardly relative to the frame about the composite axis a1. The left wheel 112a is subsequently caused to move downwardly and forwardly relative to the frame 50. In some embodiments, the movement of the left and/or right wheels 112a, 112b could be limited by the stopper S (which is schematically shown in FIG. 5C).

Therefore, it will be appreciated that the articulation assembly 210 helps to equilibrate a load applied to the track 70 when rolling on uneven ground or overcoming an obstacle 230. By means of the articulation assembly 210, one wheel of the leading wheel assembly 60a places a load on the track 70 as it is displaced by the obstacle 230, whilst the other wheel of the leading wheel assembly 60a also places a load on the track 70 as it is moved reactively. In such manner, a single high loading of the track 70 is avoided. When the articulation assembly 210 is used in conjunction with the tensioning assembly 200, if present, the composite roll and yaw movement components of the wheels of the leading wheel assembly 60a can provide a more even distribution of the load applied to the track 70, while contributing in maintaining the predetermined tension in the track 70.

By means of certain embodiments of the articulation assembly, the axle 62a has at least two degrees of freedom in the absence of a tensioning assembly 200, and at least three degrees of freedom when the tensioning assembly 200 is provided. In yet other embodiments, the axle 62a has at least three degrees of freedom when the composite movement component 220 comprises a ball joint, regardless of whether or not a tensioning assembly 200 is provided. The additional degree of freedom compared to prior art systems may provide a more fluid movement of the track system 20a when overcoming obstacles.

As seen in FIG. 5C, an angle “alpha” is depicted to illustrate the effect of the articulation assembly 210 on the track 70. Even if the track 70 is not actually deformed according to this angle, it represents the load distribution of both left and right wheels 112a, 112b of the leading wheel assembly 60a when overcoming an obstacle or an uneven ground.

It is understood that the reactivity of any one of the left and right wheels 112a, 112b of the wheel assembly 60a relative to the other one of the left and right wheels 112a, 112b of the wheel assembly 60a due to the articulation assembly 210 and about the composite axis a1, illustrated by the angle “alpha”, contributes to equilibrate the load distribution from the left and right wheels 112a, 112b on the endless track 70 when traveling on an uneven ground surface. For example, when the left wheel 112a meets and rolls over a convex obstacle, the left wheel 112a moves away from the endless track 70, which relieves the portion of the endless track 70 it engages with, and therefore applies a force thereon smaller than in the absence of the articulation assembly 210, whilst the right wheel 112b reactively moves oppositely toward the endless track 70 and applies a force on the portion of the endless track 70 it engages with that is greater than in absence of the articulation assembly 210, so that, overall, the reactive movement of the wheel assembly 60a provides an even distribution of the load applied to the endless track 70.

It is understood that the angle ‘alpha’ illustrates the collaboration between the left and right wheels 112a, 112b thanks to the articulation assembly 210, where the angle ‘alpha’ is the total relative movement of the left wheel 112a (herein moving rearwardly, angle ‘alpha−’) and the right wheel 112b (herein moving forwardly, angle ‘alpha+’). Without the relative movement of the left and right wheels 112a, 112b it is understood that a peak of pressure or stress would occur on the left wheel 112a and relatively negligeable change on the right wheel 112b.

Persons skilled in the art would appreciate that an even load distribution on the endless track 70 is desirable since it reduces peaks of pressure and stress thereon and thus increases its durability. In some cases, reducing peaks of pressure and stress applied on the endless track 70 can help to maintain alignment of the endless track 70 relative to the frame 50 of the track system 20a and to reduce wear thereof and/or risk of disengagement

Modifications and improvements to the above-described embodiments of the present invention may become apparent to those skilled in the art. The foregoing description is intended to be exemplary rather than limiting. The scope of the present invention is therefore intended to be limited solely by the appended claims.

1. An articulation assembly for an axle of a wheel assembly of a track system of a vehicle, the articulation assembly comprising:
a composite movement component configured to connect the axle of the wheel assembly to a frame of the track system, and configured to permit the axle of the wheel assembly to move relative to the frame as a composite movement having a composite axis,
the composite axis extending along a longitudinal centre plane of the track system, and
the composite movement comprising a yaw movement component and a roll movement component such that when the axle of the wheel assembly moves relative to the frame, the composite movement comprises the roll movement and the yaw movement occurring simultaneously.

2. The articulation assembly of claim 1, wherein the composite axis is angularly off-set by a first acute angle from a portion of a transverse axis of the track system which is above a horizontal axis, the horizontal axis being transverse with the composite axis at the longitudinal centre plane.

3. The articulation assembly of claim 1, wherein the composite axis is oriented to be:
angled forwardly with respect to the frame;
angled rearwardly with respect to the frame; or
substantially vertical.

4. The articulation assembly of claim 1, wherein the composite axis is substantially transverse to a resultant force direction of a tension in an endless track of the track system.

5. The articulation assembly of claim 4, wherein the composite axis is perpendicular to a resultant force direction of a tension in the endless track of the track system.

6. The articulation assembly of claim 1, further comprising a tensioning assembly configured to resiliently bias the wheel assembly away from the frame and towards an endless track of the track system, wherein the articulation assembly is connected to the tensioning assembly.

7. The articulation assembly of claim 6, wherein the articulation assembly is disposed on the axle, or is disposed between the axle and the tensioning assembly.

8. The articulation assembly of claim 1, further comprising a tensioning assembly configured to resiliently bias the wheel assembly away from the frame and towards an endless track of the track system, wherein the articulation assembly is connected to the frame.

9. The articulation assembly of claim 8, wherein the articulation assembly is disposed between the tensioning assembly and the frame, or is positioned between first and second portions of the frame.

10. The articulation assembly of claim 1, wherein the composite movement component comprises at least one member of interconnecting members associated with the axle and the frame respectively, the interconnecting members being moveable relative to each other in at least two degrees of freedom to permit the composite movement.

11. The articulation assembly of claim 1, wherein the composite movement component comprises a pivot joint or a ball joint.

12. The articulation assembly of claim 1, further comprising at least one stopper for delimiting the composite movement.

13. The articulation assembly of claim 1, wherein the wheel assembly comprises two wheels, spaced from one another and connected to the axle, and wherein the two wheels are configured to contact respective portions on an inner surface of the endless track.

14. The articulation assembly of claim 1, wherein the wheel assembly comprises an idler wheel assembly or a support wheel assembly.

15. An articulation assembly for an axle of a wheel assembly of a track system of a vehicle, the articulation assembly comprising:
a composite movement component configured to connect the axle of the wheel assembly to a frame of the track system, and configured to permit the axle of the wheel assembly to move relative to the frame as a composite movement having a composite axis, the composite axis extending along a longitudinal centre plane of the track system, the composite movement having at least two degrees of freedom.

16. The articulation assembly of claim 15, wherein the at least two degrees of freedom comprise a roll movement component and a yaw movement component.

17. The articulation assembly of claim 15, further comprising a tensioning assembly, the at least two degrees of freedom comprising three degrees of freedom.

18. A wheel assembly for a track system for a vehicle, the wheel assembly comprising an axle supporting wheels, and an articulation assembly configured to connect the axle to a frame of the track system and to permit a composite movement, the articulation assembly as defined in claim 1.

19. A track system for a vehicle, the track system comprising:
a frame;
at least one wheel assembly having an axle supporting wheels;
an endless track supported by the wheels;
an articulation assembly configured to connect the axle to a frame of the track system and to permit a composite movement with a composite axis, the articulation assembly as defined in claim 1.

20. An articulation assembly for an axle of a wheel assembly of a track system of a vehicle, the wheel assembly comprising an endless track supported by wheels, the articulation assembly comprising:
a composite movement component configured to connect the axle of the wheel assembly to a frame of the track system, and configured to permit the axle of the wheel assembly to move relative to the frame as a composite movement having a composite axis,
the composite axis extending along a longitudinal centre plane of the track system, the composite movement comprising a yaw movement component and a roll movement component such that when the axle of the wheel assembly moves relative to the frame, the composite movement is configured to evenly distribute a stress within the endless track when the endless track is contact with uneven ground.
